(19) United States
(12) Patent Application Publication
(10) Pub. No.: US 2005/0140764 A1
(43) Pub. Date: Jun. 30, 2005

(54) Ink-jet printing apparatus

(75) Inventors: Yih Chang, Jhonghe City (TW); Tung-Sheng Cheng, Hsinchu (TW); Pei-Chuan Yeh, Miaoli City (TW)

Correspondence Address: BIRCH STEWART KOLASCH & BIRCH, PO BOX 747, FALLS CHURCH, VA, 22040-0747, US

(73) Assignee: RITDISPLAY CORPORATION

(21) Appl. No.: 10/963,661

(22) Filed: Oct. 14, 2004

(30) Foreign Application Priority Data
Dec. 31, 2003 (TW) 092137856

(51) Int. Cl. B41J 2/01

(52) U.S. Cl. 347/102

(57) ABSTRACT

An ink-jet printing apparatus for printing at least one organic material on a substrate comprises a delivering chamber, a loading mechanism, at least one ink-jet printing mechanism, a heat treatment process mechanism and an unloading mechanism. In this case, the delivering chamber has a delivering unit, which carries the substrate from the loading mechanism and carries the substrate to the unloading mechanism. The ink-jet printing mechanism connects to the delivering chamber and prints the organic material on the substrate. The heat treatment process mechanism connects to the delivering chamber and heats the substrate on which the organic material is formed. The unloading mechanism connects with the delivering chamber.

### BACKGROUND OF THE INVENTION

1. Field of Invention

The invention relates to an ink-jet printing apparatus and, in particular, to an ink-jet printing apparatus applied for manufacturing organic light-emitting displays (OLED).

2. Related Art

The flat-panel displays have been developed based on the trend towards high brightness, planar and thinner structures, and power saving. Accordingly, the organic electroluminescent display panel is one of the most potential products in optoelectronics industries. The organic electroluminescent display panel uses the self-emitting feature of organic functional materials to perform display purposes. According to the molecular weight of the organic functional materials used in organic electroluminescent display panel, it could be distinguished into small molecule OLED (SM-OLED) panel and polymer light-emitting display (PLED) panel.

As shown in FIG. 1, the conventional organic electroluminescent display panel 6 comprises an anode substrate 61, an organic functional layer 62, and a cathode 63. The organic functional layer 62 and the cathode 63 are formed, in sequence, on the anode substrate 61, wherein the organic functional layer 62 is formed on the anode substrate 61 by an ink-jet printing method.

In the conventional ink-jet printing processes, the anode substrate 61 is manually moved into an ink-jet printing apparatus. The ink-jet printing apparatus comprises an ink-jet head, which is filled with an organic material such as a red-light electroluminescent material. The ink-jet head then prints the organic material on the anode substrate 61 as required. Next, another organic material, such as a blue-light electroluminescent material, is loaded, and the ink-jet head prints this organic material on the anode substrate 61 as required. After that, the above-mentioned steps can be repeated to print different organic materials on the anode substrate 61.

In the previously mentioned processes, however, the manually moving not only wastes time and manpower, but also leads to the exposure of the organic electroluminescent display panel with air during the moving, which results in a shortened lifetime of the panel. In addition, the loaded organic materials pollute each other since the different organic materials may be loaded in the same ink-jet head. Moreover, it wastes time for loading the different organic materials.

It is therefore a subjective of the invention to provide an ink-jet printing apparatus for solving the above-mentioned problems.

### SUMMARY OF THE INVENTION

In view of the foregoing, the invention is to provide an ink-jet printing apparatus, which is suitable for mass production and can prevent the pollution.

The invention is to provide an ink-jet printing apparatus, which has proper arrangements as required, so that the adjustment of the apparatus has better flexibility and the performance of the apparatus is improved.

The invention is to provide an ink-jet printing apparatus, which can prevent the jam of production line when a single apparatus is malfunction.

The invention is to provide an ink-jet printing apparatus, which can save the cost of manually moving, prevent the troubles caused by labor operations, and ensure the quality, lifetime and reliability of panels.

The invention is to provide an ink-jet printing apparatus, which is an automatic and integrated mass production apparatus, so that the throughput can be increased and the yield can be increased.

To achieve the above, an ink-jet printing apparatus of the invention, which is for printing at least one organic material on a substrate, comprises a delivering chamber, a loading mechanism, at least one ink-jet printing mechanism, a heat treatment process mechanism, and an unloading mechanism. The delivering chamber has a delivering unit for delivering the substrate. The loading mechanism connects to the delivering chamber, and the delivering unit carries the substrate from the loading mechanism. The ink-jet printing mechanism connects to the delivering chamber and prints the organic material on the substrate. The heat treatment process mechanism connects to the delivering chamber and heats the substrate with the printed organic material. The unloading mechanism connects to the delivering chamber, and the delivering unit carries the substrate to the unloading mechanism.

To achieve the above, an ink-jet printing apparatus of the invention, which is for printing at least one organic material on a substrate, comprises a loading device, at least one ink-jet printing device, an unloading device, a plurality of heat treatment process devices, and a plurality of cooling devices. The loading device comprises a first delivering chamber and a loading chamber connecting to the first delivering chamber. The ink-jet printing device comprises at least one first ink-jet printing chamber and a second delivering chamber connecting to the first ink-jet printing chamber. The second delivering chamber connects to the first delivering chamber. The unloading device comprises a third delivering chamber and an unloading chamber connecting to the third delivering chamber. The third delivering chamber connects to the second delivering chamber. The heat treatment process devices are respectively disposed between the first delivering chamber and the second delivering chamber and between the second delivering chamber and the third delivering chamber. The cooling devices are respectively disposed between the first delivering chamber and the second delivering chamber and between the second delivering chamber and the third delivering chamber.

To achieve the above, an ink-jet printing apparatus of the invention, which is for printing at least one organic material on a substrate, comprises a loading device, a plurality of ink-jet printing devices, an unloading mechanism, a plurality of heat treatment process devices, and a plurality of cooling devices. The loading device comprises a first delivering chamber and a loading chamber connecting to the first delivering chamber. The ink-jet printing device comprises at least one first ink-jet printing chamber and a second delivering chamber connecting to the first ink-jet printing chamber. The second delivering chambers connect to one another. The unloading mechanism comprises a third delivering chamber and an unloading chamber connecting to the third delivering chamber. One of the second delivering chambers connects to the third delivering chamber, and one of the second delivering chambers connects to the first delivering chamber. The heat treatment process devices are respectively disposed between the first delivering chamber and the second delivering chambers, between the second delivering chambers and the third delivering chamber, and between every two of the second delivering chambers. The cooling devices are respectively disposed between the first delivering chamber and the second delivering chambers, between the second delivering chambers and the third delivering chamber, and between every two of the second delivering chambers.

To achieve the above, an ink-jet printing apparatus of the invention, which is for printing at least one organic material on a substrate, comprises a loading device, a plurality of ink-jet printing devices, an unloading mechanism, a plurality of heat treatment process devices, and a plurality of cooling devices. The loading device comprises a first delivering chamber and a loading chamber connecting to the first delivering chamber. The ink-jet printing device comprises a plurality of second delivering chambers and a plurality of first ink-jet printing chambers. The second delivering chamber connects to at least one of the first ink-jet printing chambers, and the second delivering chambers connect to one another. The unloading mechanism comprises a third delivering chamber and an unloading chamber connecting to the third delivering chamber. One of the second delivering chambers of the ink-jet printing device connects to the third delivering chamber, and one of the second delivering chambers of the ink-jet printing device connects to is the first delivering chamber. The heat treatment process devices are respectively disposed between the first delivering chamber and the second delivering chambers, between the second delivering chambers and the third delivering chamber, and between every two of the second delivering chambers. The cooling devices are respectively disposed between the first delivering chamber and the second delivering chambers, between the second delivering chambers and the third delivering chamber, and between every two of the second delivering chambers.

To achieve the above, an ink-jet printing apparatus of the invention, which is for printing at least one organic material on a substrate, comprises a delivering chamber, at least one ink-jet printing mechanism, and a heat treatment process mechanism. The delivering chamber comprises a delivering unit for delivering the substrate. The ink-jet printing mechanism connects to the delivering chamber and prints the organic material on the substrate. The heat treatment process mechanism connects to the delivering chamber and heats the substrate with the printed organic material.

As mentioned above, the ink-jet printing apparatus of the invention has proper arrangements as required. Comparing with the conventional art, the invention can change the number of the ink-jet printing device (ink-jet printing mechanism) and the positions and number of other devices (mechanisms) according to different situations. Thus, the adjustment of the apparatus has better flexibility. For example, when the throughput of the current apparatus is insufficient, the additional ink-jet print chambers (ink-jet print mechanisms) can be installed on the delivering chamber. This can increase the throughput without ordering another apparatus for larger throughput. In addition, when one ink-jet printing device is malfunction, other ink-jet print devices can keep working. Moreover, the organic material is printed in the assigned ink-jet print chamber (ink-jet print mechanism), so time for changing the material can be saved and the pollution of the different organic materials can be prevented. Furthermore, the manually moving is unnecessary in the ink-jet print processes of the invention, so not only the time cost for the manual operation can be saved, but also the organic electroluminescent panel can be prevented from the air, which results in the dark spots. Therefore, the lifetime and reliability of the panel can be assured. In addition, since ink-jet printing apparatus of the invention an automatic and integrated mass production apparatus, so that the throughput can be increased and the yield can be greatly increased.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing the conventional organic electroluminescent display panel;

FIG. 2 is a schematic view showing an ink-jet printing apparatus according to a first embodiment of the invention;

FIG. 3 is a schematic view showing an ink-jet printing apparatus according to a second embodiment of the invention;

FIG. 4 is a schematic view showing an ink-jet printing apparatus according to a third embodiment of the invention;

FIG. 5 is a schematic view showing an ink-jet printing apparatus according to a fourth embodiment of the invention;

FIG. 6 is a schematic view showing an ink-jet printing apparatus according to a fifth embodiment of the invention; and

FIG. 7 is a schematic view showing an ink-jet printing apparatus according to a sixth embodiment of the invention.

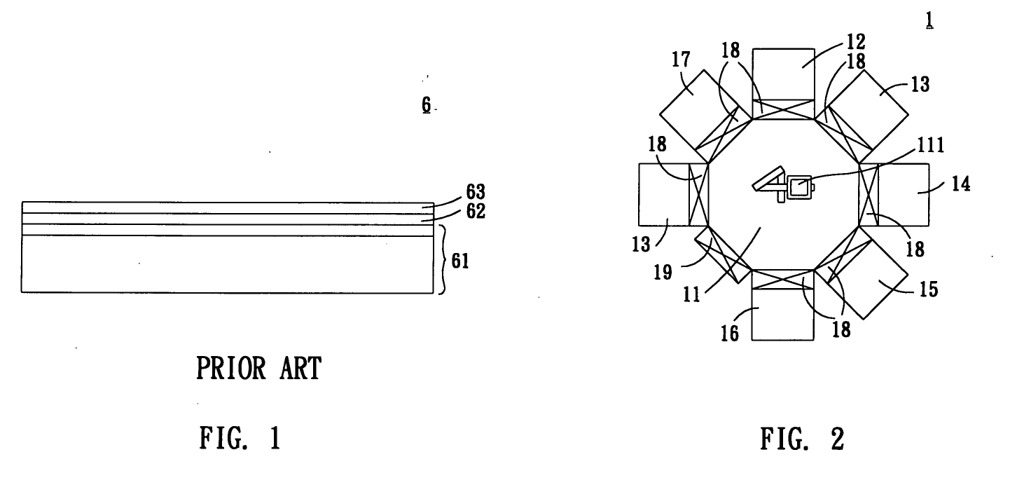

### DETAILED DESCRIPTION OF THE INVENTION

The present invention will be apparent from the following detailed description, which proceeds with reference to the accompanying drawings, wherein the same references relate to the same elements.

### First Embodment

With reference to FIG. 2, an ink-jet printing apparatus 1 according to the first embodiment of the invention, which is for printing at least one organic material on a substrate, comprises a delivering chamber 11, a loading mechanism 12, at least one ink-jet printing mechanism 13, a heat treatment process mechanism 14, and an unloading mechanism 15. In the embodiment, the delivering chamber 11 has a delivering unit 111 for delivering the substrate. The loading mechanism 12 connects to the delivering chamber 11, and the delivering unit 111 carries the substrate from the loading mechanism 12. The ink-jet printing mechanism 13 connects to the delivering chamber 11 and prints the organic material on the substrate. The heat treatment process mechanism 14 connects to the delivering chamber 11 and heats the substrate with the printed organic material. The unloading mechanism 15 connects to the delivering chamber 11, and the delivering unit 111 carries the substrate to the unloading mechanism 15.

In the embodiment, the substrate is an electrode substrate, such as an ITO (indium-tin oxide) substrate, an AZO (aluminum-zinc oxide) substrate, or an IZO (indium-zinc oxide) substrate. Of course, the electrode substrate can be a substrate having a surface formed with a metal.

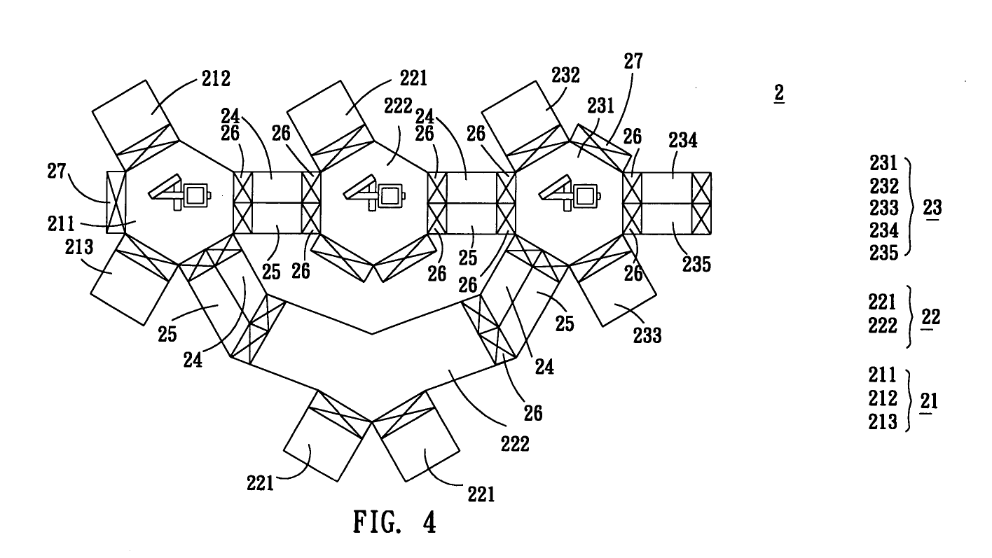

In the present embodiment, the delivering chamber 11 can be a polygon configuration structure, such as an octagon configuration structure as shown in FIG. 2. Of course, the delivering chamber 11 can be any shaped configuration structure, such as an irregular shaped configuration structure as shown in FIG. 4. The delivering unit 111 can be a robot arm, a transporting axle or a transporting belt. When performing the ink-jet printing processes, the substrate is moved to the ink-jet printing mechanism 13, the heat treatment process mechanism 14, or the unloading mechanism 15 with the delivering unit 111. Accordingly, an ink-jet printing process, a heat treatment process, or an unloading process can be performed.

The organic materials are very sensitive to moisture and oxygen, so that dark spots may be formatted when the materials contact with air. Therefore, the delivering chamber 11 is capable of exhausting air to provide vacuum or then to fill with inert gas as required. Thus, the processes can be performed under vacuum or inert gas environment, so that the dark spots can be decreased. The exhausting system (not shown) of the delivering chamber 11 may comprise a rotary pump, a mechanical pump, a turbo molecular pump, or a low-temperature pump. In this case, the delivering chamber 11 can reach vacuum state in a short time.

In addition, the delivering chamber 11 may further comprise a gate, which comprises a valve 19. Herein, the gate is used for installing additional mechanisms, so that the ink-jet printing apparatus 1 can be changed any time to match the throughput requirement of different situations.

Referring to FIG. 2 again, the loading mechanism 12 connects to the delivering chamber 11, and the delivering unit 111 can carry the substrate from the loading mechanism 12. In this embodiment, the substrate is positioned in the loading mechanism 12, and the delivering unit 111 then carries the substrate to other mechanisms for the later processes.

In addition, as shown in FIG. 2, the ink-jet printing mechanism 13 connects to the delivering chamber 11, and prints the organic material on the substrate. Herein, the ink-jet printing mechanism 13 comprises an ink-jet printing unit (not shown) and a material storage unit (not shown). When the ink-jet printing mechanism 13 works, the ink-jet printing unit prints the organic material stored in the material storage unit to the substrate. As shown in FIG. 2, there are two ink-jet printing mechanisms 13 in this case, and the ink-jet printing unit prints different organic material on the substrate. Herein, the pollution of changing different organic materials as described in the conventional art can be prevented.

In addition, the organic material of the embodiment can be the same material for forming a buffer layer, such as a hole-injecting layer, a hole-transporting layer, an electroluminescent layer, an electron-transporting layer or an electron-injecting layer. Alternatively, the organic material of the embodiment can be the same material for forming an electroluminescent layer, which can emit light such as blue light, green light, red light, white light, or other monochromatic light.

With reference to FIG. 2, the heat treatment process mechanism 14 connects to the delivering chamber 11 and heats the substrate with the printed organic material. The heat treatment process mechanism 14 provides heat to evaporate the organic solvent, so that the process time can be shortened. In the embodiment, the heat treatment process mechanism 14 comprises a heating unit and a heat controller (not shown). The heating unit can be a hot plate or an oven. Take the hot plate as an example, the hot plate has a platform with an internal pipe, and the pipe is filled with a fluid for changing the temperature of the platform. For example, the fluid can be water, and the heat controller can transfer the water of different temperature to the pipe for adjusting the temperature of the platform. Alternatively, the hot plate may have a platform with an internal heating coil, which can transform the electronic energy into heat for increasing the temperature of the platform.

In addition, the heat treatment process mechanism 14 may further comprise an exhausting-charging unit. When the organic solvent is evaporated, the exhausting-charging unit can exhaust air of the heat treatment process mechanism 14 for providing vacuum. Then, the exhausting-charging unit can charge inert gas into the heat treatment process mechanism 14 to maintain it in a constant atmosphere.

As shown in FIG. 2, the unloading mechanism 15 connects to the delivering chamber 11, and the delivering unit 111 carries the substrate to the unloading mechanism 15 from other mechanisms.

With reference to FIG. 2, the ink-jet printing apparatus 1 of the embodiment further comprises a cooling mechanism 16, which connects to the delivering chamber 11 and cools the substrate treated by the heat treatment process. This can shorten the waiting time for cooling the substrate. In the embodiment, the cooling mechanism 16 comprises a cooling unit and a cool controller (not shown). The cooling unit can be a cool plate. Take the cool plate as an example, the cool plate has a platform with an internal pipe, and the pipe is filled with a fluid for changing the temperature of the platform. For example, the fluid can be water, and the cool controller can transfer the water of different temperature to the pipe for adjusting the temperature of the platform.

As shown in FIG. 2, the ink-jet printing apparatus 1 of the embodiment further comprises a pre-treatment mechanism 17, which connects to the delivering chamber 11. The pre-treatment mechanism 17 is used to clean the substrate by, for example, plasma cleaning.

In the embodiment, with reference to FIG. 2, a plurality of valves 18 are provided, and the valve is disposed between the delivering chamber 11 and the loading mechanism 12, the ink-jet printing mechanism 13, the heat treatment process mechanism 14, the cooling mechanism 16, the pre-treatment mechanism 17 and the unloading mechanism 15. The valves 18 can isolate the atmosphere between the mechanisms.

### Second Embodiment

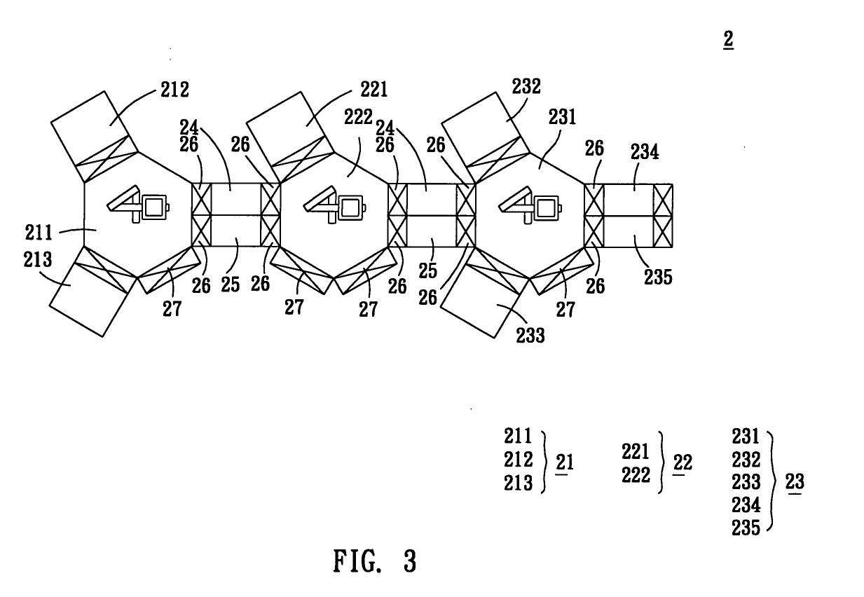

With reference to FIG. 3, an ink-jet printing apparatus 2 according to the second embodiment of the invention, which is for printing at least one organic material on a substrate, comprises a loading device 21, at least one ink-jet printing device 22, an unloading device 23, a plurality of heat treatment process devices 24 and a plurality of cooling devices 25. In the embodiment, the loading device 21 comprises a first delivering chamber 211 and a loading chamber 212 connecting to the first delivering chamber 211. The ink-jet printing device 22 comprises at least one first ink-jet printing chamber 221 and a second delivering chamber 222 connecting to the first ink-jet printing chamber 221. The second delivering chamber 222 connects to the first delivering chamber 211. The unloading device 23 comprises a third delivering chamber 231 and an unloading chamber 232 connecting to the third delivering chamber 231. The third delivering chamber 231 connects to the second delivering chamber 222. The heat treatment process devices 24 are respectively disposed between the first delivering chamber 211 and the second delivering chamber 222, and between the second delivering chamber 222 and the third delivering chamber 231. The cooling devices 25 are respectively disposed between the first delivering chamber 211 and the second delivering chamber 222 and between the second delivering chamber 222 and the third delivering chamber 231.

As shown in FIG. 3, the first delivering chamber 211, the second delivering chamber 222 and the third delivering chamber 231 further comprises at least one gate, and the gate comprises a valve 27. Herein, the gate is used for installing additional chambers, so that the ink-jet printing apparatus 2 can be changed any time to match the throughput requirement and process changing of different situations.

Referring to FIG. 3, the loading device 21 further comprises at least one second ink-jet printing chamber 213 connecting to the first delivering chamber 211.

The unloading device 23 further comprises at least one third ink-jet printing chamber 233 connecting to the third delivering chamber 231.

In the embodiment, the features and functions of the first delivering chamber 211, the second delivering chamber 222 and the third delivering chamber 231 are the same to the delivering chamber 11 described in the first embodiment, the features and functions of the loading chamber 212 are the same to the loading mechanism 12 described in the first embodiment, the features and functions of the first ink-jet printing chamber 221, the second ink-jet printing chamber 213 and the third ink-jet printing chamber 233 are the same to the ink-jet printing mechanism 13 described in the first embodiment, the features and functions of the heat treatment process devices 24 and the cooling devices 25 are the same to the heat treatment process mechanism 14 and the cooling mechanism 16 described in the first embodiment, and the features and functions of the unloading chamber 232 are the same to the unloading mechanism 15 described in the first embodiment, so the detailed descriptions are omitted here for concise purpose.

The organic material to be printed on the substrate of the embodiment is the same to that described in the first embodiment, so the detailed descriptions are omitted here for concise purpose.

In the present embodiment, the unloading device 23 further comprises an annealing unit 234 for annealing the substrate. Herein, the annealing unit 234 is a hot plate or an oven. In the embodiment, whether the annealing process is performed or not is determined according to the characteristic of the organic material. In addition, the unloading device 23 may further comprise a cooler 234.

As shown in FIG. 3, a plurality of valves 26 are provided, and the valve 26 is disposed on the interfaces of the first delivering chamber 211, the loading chamber 212, the first ink-jet printing chamber 221, the second ink-jet printing chamber 213, the third ink-jet printing chamber 233, the second delivering chamber 222, the third delivering chamber 231, the unloading chamber 232, the heat treatment process devices 24 and the cooling devices 25. Of course, the valve can be removed from where between the cooling devices 25 and the first delivering chamber 211, the second delivering chamber 222 and the third delivering chamber 231.

In the current embodiment, a delivering unit of the first delivering chamber 211 carries the substrate from the loading chamber 212 and carries it to the second ink-jet printing chamber 213. In the second ink-jet printing chamber 213, an organic material, such as a buffer layer, is printed on the substrate. The delivering unit of the first delivering chamber 211 then carries the substrate with the printed organic material from the second ink-jet printing chamber 213 to the heat treatment process device 24. The heat treatment process device 24 heats the substrate to remove the organic solvent, wherein the heat treatment process device 24 is exhausted to obtain vacuum and is then filled with inert gas to maintain itself in a constant atmosphere. A delivering mechanism, such as a robot arm, is installed between the heat treatment process device 24 and the cooling device 25, and carries the substrate treated by the heat treatment process from the heat treatment process device 24 to the cooling device 25 for cooling. Then, a delivering unit of the second delivering chamber 222 carries the substrate from the cooling device 25 to the first ink-jet printing chamber 221. In the first ink-jet printing chamber 221, another organic material, such as an electroluminescent layer, is printed on the substrate formed with the buffer layer. The delivering unit of the second delivering chamber 222 then carries the substrate formed with the buffer layer and electroluminescent layer from the first ink-jet printing chamber 221 to the heat treatment process device 24. The heat treatment process device 24 heats the substrate to remove the organic solvent, wherein the heat treatment process device 24 is exhausted to obtain vacuum and is then filled with inert gas to maintain itself in a constant atmosphere. A delivering mechanism, such as a robot arm, is installed between the heat treatment process device 24 and the cooling device 25, and carries the substrate treated by the heat treatment process from the heat treatment process device 24 to the cooling device 25 for cooling. Then, a delivering unit of the third delivering chamber 231 carries the substrate from the cooling device 25 to the third ink-jet printing chamber 233. In the third ink-jet printing chamber 233, an additional ink-jet process is performed. Finally, a delivering unit of the third delivering chamber 231 carries the substrate to the unloading device 232 for unloading operations.

Of course, the substrate can be delivered between the heat treatment process device 24 and the cooling device 25 by the delivering unit of the first delivering chamber 211, the second delivering chamber 222, or the third delivering chamber 231.

In addition, except for heat treatment and cool treatment, the heat treatment process device 24 and the cooling device 25 of the embodiment can be also used as delivering chambers.

### Third Embodiment

With reference to FIG. 4, except for that there are two ink-jet printing devices 22 in the embodiment, other elements are the same to those of the second embodiment. The features and functions of the individual element are the same to those of the second embodiment described previously, so the detailed descriptions are omitted here for concise purpose.

In addition, one of the second delivering chambers 222 of the embodiment has irregular shaped configuration structure.

In the present embodiment, when one of the ink-jet printing devices 22 is malfunctioned and should be stopped, the operator can continuously perform the ink-jet printing process with other ink-jet printing device 22. Thus, the malfunctioned ink-jet printing device 22 would not lead to the stop of the whole ink-jet printing apparatus 2. Of course, both the ink-jet printing devices 22 can be operated at the same time, so as to increase the total throughput.

Of course, the ink-jet printing apparatus 2 can comprise a plurality of ink-jet printing devices 22 as required.

### Fourth Embodiment

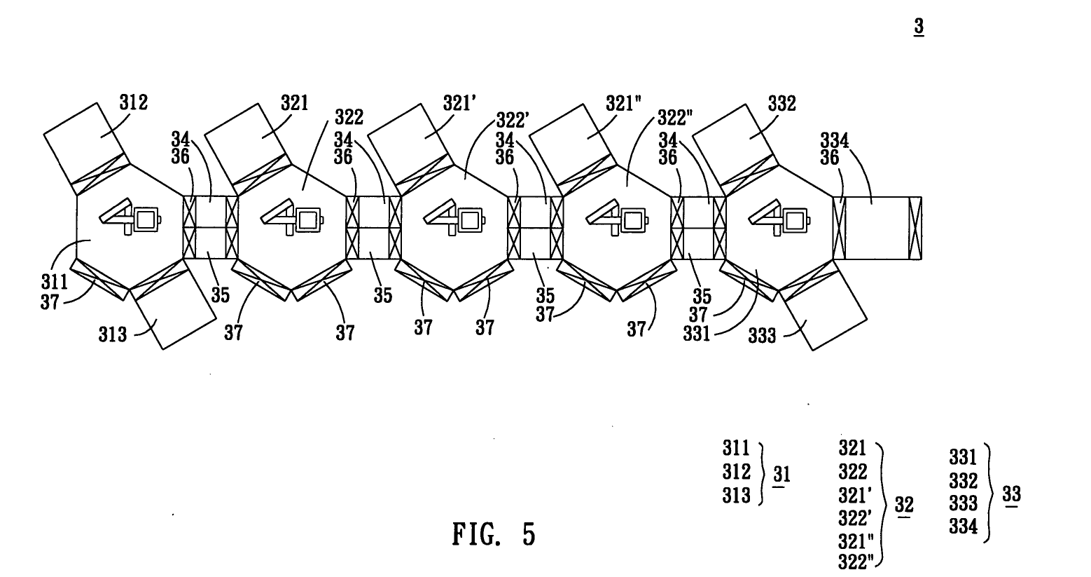

With reference to FIG. 5, an ink-jet printing apparatus 3 according to the fourth embodiment of the invention, which is for printing at least one organic material on a substrate, comprises a loading device 31, a plurality of ink-jet printing devices 32, an unloading device 33, a plurality of heat treatment process devices 34 and a plurality of cooling devices 35. The loading device 31 comprises a first delivering chamber 311 and a loading chamber 312 connecting to the first delivering chamber 311. The ink-jet printing device 32 comprises at least one first ink-jet printing chamber 321 and a second delivering chamber 322 connecting to the first ink-jet printing chamber 321. The second delivering chambers 322 connect to one another. The unloading device 33 comprises a third delivering chamber 331 and an unloading chamber 332 connecting to the third delivering chamber 331. One of the second delivering chambers 322 connects to the third delivering chamber 331, and one of the second delivering chambers 322 connects to the first delivering chamber 311. The heat treatment process devices 34 are respectively disposed between the first delivering chamber 311 and the second delivering chambers 322, between the second delivering chambers 322 and the third delivering chamber 331, and between every two of the second delivering chambers 322. The cooling devices 35 are respectively disposed between the first delivering chamber 311 and the second delivering chambers 322, between the second delivering chambers 322 and the third delivering chamber 331, and between every two of the second delivering chambers 322.

As shown in FIG. 5, the first delivering chamber 311, the second delivering chamber 322 and the third delivering chamber 331 further comprises at least one gate, and the gate comprises a valve 37. Herein, the gate is used for installing additional chambers, so that the ink-jet printing apparatus 3 can be changed any time to match the throughput requirement and process changing of different situations.

Referring to FIG. 5, the loading device 31 further comprises at least one second ink-jet printing chamber 313 connecting to the first delivering chamber 311.

The unloading device 33 further comprises at least one third ink-jet printing chamber 333 connecting to the third delivering chamber 331.

In the embodiment, the features and functions of the first delivering chamber 311, the second delivering chamber 322 and the third delivering chamber 331 are the same to the delivering chamber 11 described in the first embodiment, the features and functions of the loading chamber 312 are the same to the loading mechanism 12 described in the first embodiment, the features and functions of the first ink-jet printing chamber 321, the second ink-jet printing chamber 313 and the third ink-jet printing chamber 333 are the same to the ink-jet printing mechanism 13 described in the first embodiment, the features and functions of the heat treatment process devices 34 and the cooling devices 35 are the same to the heat treatment process mechanism 14 and the cooling mechanism 16 described in the first embodiment, and the features and functions of the unloading chamber 332 are the same to the unloading mechanism 15 described in the first embodiment, so the detailed descriptions are omitted here for concise purpose.

The organic material to be printed on the substrate of the embodiment is the same to that described in the first embodiment, so the detailed descriptions are omitted here for concise purpose.

In the present embodiment, the unloading device 33 further comprises an annealing unit 334 for annealing the substrate. Herein, the annealing unit 334 is a hot plate or an oven. In the embodiment, whether the annealing process is performed or not is determined according to the characteristic of the organic material. As shown in FIG. 4, the annealing unit 334 is an oven.

As shown in FIG. 5, a plurality of valves 36 are provided, and the valve 36 is disposed on the interfaces of the first delivering chamber 311, the loading chamber 312, the first ink-jet printing chamber 321, the second ink-jet printing chamber 313, the third ink-jet printing chamber 333, the second delivering chamber 322, the third delivering chamber 331, the unloading chamber 332, the heat treatment process devices 34 and the cooling devices 35. Of course, the valve can be removed from where between the cooling devices 35 and the first delivering chamber 311, the second delivering chamber 322 and the third delivering chamber 331.

In the current embodiment, a delivering unit of the first delivering chamber 311 carries the substrate from the loading chamber 312 and carries it to the second ink-jet printing chamber 313. In the second ink-jet printing chamber 313, an organic material, such as a red light material, is printed on the substrate. The delivering unit of the first delivering chamber 311 then carries the substrate with the printed organic material from the second ink-jet printing chamber 313 to the heat treatment process device 34. The heat treatment process device 34 heats the substrate to remove the organic solvent, wherein the heat treatment process device 34 is exhausted to obtain vacuum and is then filled with inert gas to maintain itself in a constant atmosphere. A delivering mechanism, such as a robot arm, is installed between the heat treatment process device 34 and the cooling device 35, and carries the substrate treated by the heat treatment process from the heat treatment process device 34 to the cooling device 35 for cooling. Then, a delivering unit of the second delivering chamber 322 carries the substrate from the cooling device 35 to the first ink-jet printing chamber 321. In the first ink-jet printing chamber 321, another organic material, such as a green light material, is printed on the substrate. The delivering unit of the second delivering chamber 322 then carries the substrate formed with the green light material from the first ink-jet printing chamber 321 to the heat treatment process device 34. The heat treatment process device 34 heats the substrate to remove the organic solvent, wherein the heat treatment process device 34 is exhausted to obtain vacuum and is then filled with inert gas to maintain itself in a constant atmosphere. A delivering mechanism, such as a robot arm, is installed between the heat treatment process device 34 and the cooling device 35, and carries the substrate treated by the heat treatment process from the heat treatment process device 34 to the cooling device 35 for cooling. Then, a delivering unit of another second delivering chamber 322′ carries the substrate from the cooling device 35 to the another first ink-jet printing chamber 321′. In the first ink-jet printing chamber 321′, another organic material, such as a blue light material, is printed on the substrate. The delivering unit of the second delivering chamber 322′ then carries the substrate formed with the blue light material from the first ink-jet printing chamber 321′ to the heat treatment process device 34. The heat treatment process device 34 heats the substrate to remove the organic solvent, wherein the heat treatment process device 34 is exhausted to obtain vacuum and is then filled with inert gas to maintain itself in a constant atmosphere. A delivering mechanism, such as a robot arm, is installed between the heat treatment process device 34 and the cooling device 35, and carries the substrate treated by the heat treatment process from the heat treatment process device 34 to the cooling device 35 for cooling. Then, an additional first ink-jet printing device 321″, an additional second delivering chamber 322″, the third ink-jet printing chamber 333 and the third delivering chamber 331 are employed to repeat the above-mentioned steps. Finally, the substrate is carried to the unloading device 332 for unloading operations.

Of course, the substrate can be carried between the heat treatment process device 34 and the cooling device 35 by the delivering unit of the first delivering chamber 311, the second delivering chambers 322, 322′, 322″, or the third delivering chamber 331.

In the current embodiment, the ink-jet printing apparatus 3 can comprise a plurality of ink-jet printing devices 32 as required.

### Fifth Embodiment

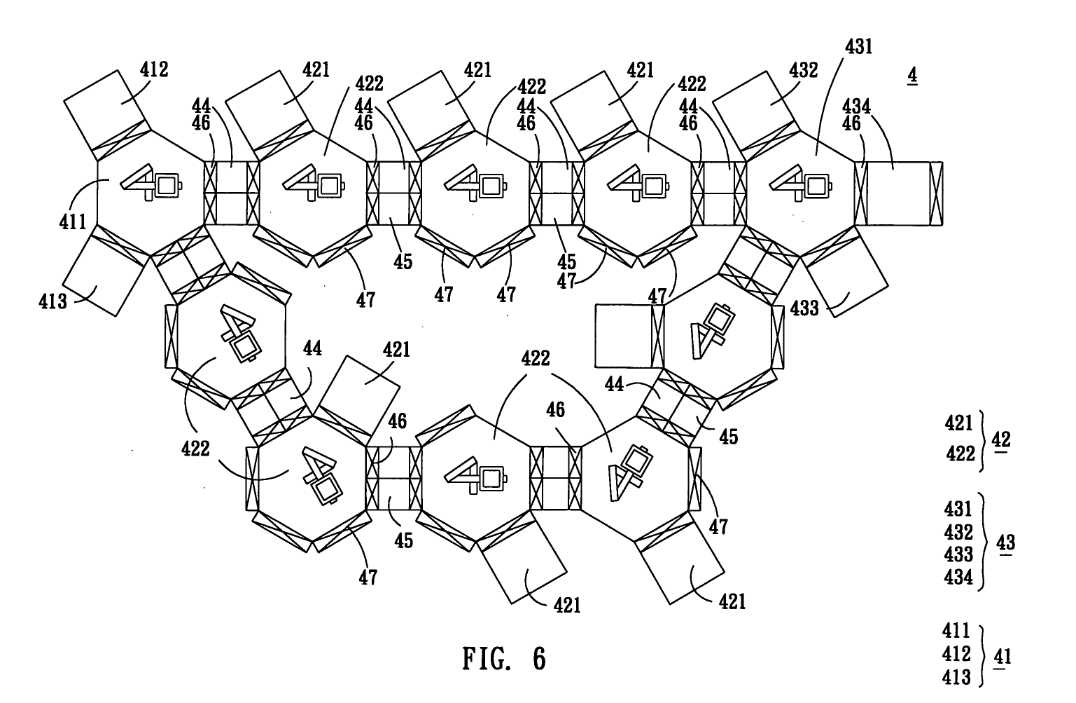

With reference to FIG. 6, an ink-jet printing apparatus 4 according to the fifth embodiment of the invention, which is for printing at least one organic material on a substrate, comprises a loading device 41, a plurality of ink-jet printing devices 42, an unloading mechanism 43, a plurality of heat treatment process devices 44 and a plurality of cooling devices 45. The loading device 41 comprises a first delivering chamber 411 and a loading chamber 412 connecting to the first delivering chamber 411. The ink-jet printing device 42 comprises a plurality of second delivering chambers 422 and a plurality of first ink-jet printing chambers 421. The second delivering chamber 422 connects to at least one of the first ink-jet printing chambers 421, and the second delivering chambers 422 connect to one another. The unloading device 43 comprises a third delivering chamber 431 and an unloading chamber 432 connecting to the third delivering chamber 431. One of the second delivering chambers 422 of the ink-jet printing device 42 connects to the third delivering chamber 431, and one of the second delivering chambers 422 of the ink-jet printing device 42 connects to is the first delivering chamber 411. The heat treatment process devices 44 are respectively disposed between the first delivering chamber 411 and the second delivering chambers 422, between the second delivering chambers 422 and the third delivering chamber 431, and between every two of the second delivering chambers 422. The cooling devices 45 are respectively disposed between the first delivering chamber 411 and the second delivering chambers 422, between the second delivering chambers 422 and the third delivering chamber 431, and between every two of the second delivering chambers 422.

The first delivering chamber 411, the second delivering chambers 422 and the third delivering chamber 431 further comprises at least one gate, and the gate comprises a valve 47.

The loading device 41 further comprises at least one second ink-jet printing chamber 413 connecting to the first delivering chamber 411. The unloading device 43 further comprises at least one third ink-jet printing chamber 433 connecting to the third delivering chamber 431.

The organic material to be printed on the substrate of the embodiment is the same to that described in the first embodiment, so the detailed descriptions are omitted here for concise purpose.

In this embodiment, the unloading device 43 further comprises an annealing unit 434 for annealing the substrate. Herein, the annealing unit 434 is a hot plate or an oven.

As shown in FIG. 6, a plurality of valves 46 are provided, and the valve 46 is disposed on the interfaces of the first delivering chamber 411, the loading chamber 412, the first ink-jet printing chamber 421, the second ink-jet printing chamber 413, the third ink-jet printing chamber 433, the second delivering chamber 422, the third delivering chamber 431, the unloading chamber 432, the heat treatment process devices 44 and the cooling devices 45. Of course, the valve can be removed from where between the cooling devices 45 and the first delivering chamber 411, the second delivering chambers 422 and the third delivering chamber 431.

Of course, the substrate can be carried between the heat treatment process device 44 and the cooling device 45 by the delivering unit of the first delivering chamber 411, the second delivering chambers 422, or the third delivering chamber 431.

With reference to FIG. 6, except for that there are eight ink-jet printing devices 42 in the embodiment, other elements are the same to those of the fourth embodiment. The features and functions of the individual element are the same to those of the fourth embodiment described previously, so the detailed descriptions are omitted here for concise purpose.

In the present embodiment, when one of the ink-jet printing devices 42 is malfunctioned and should be stopped, the operator can continuously perform the ink-jet printing process with other ink-jet printing devices 42. Thus, the malfunctioned ink-jet printing device 42 would not lead to the stop of the whole ink-jet printing apparatus 4. Of course, dual lines ink-jet printing devices 42 can be provided and operated at the same time, so as to increase the total throughput.

Of course, the ink-jet printing apparatus 4 can comprise a plurality of ink-jet printing devices 42 as required.

### Sixth Embodiment

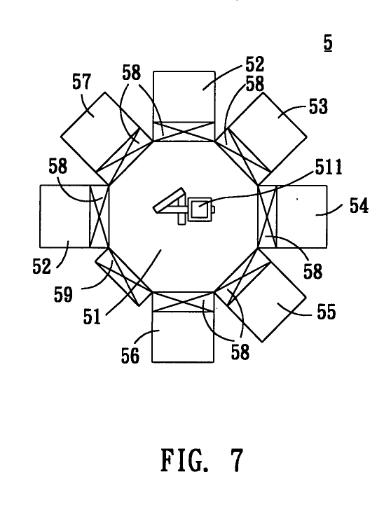

With reference to FIG. 7, an ink-jet printing apparatus 5 according to the sixth embodiment of the invention, which is for printing at least one organic material on a substrate, comprises a delivering chamber 51, at least one ink-jet printing mechanism 52 and a heat treatment process mechanism 53. The delivering chamber 51 comprises a delivering unit 511 for delivering the substrate. The ink-jet printing mechanism 52 connects to the delivering chamber 51 and prints the organic material on the substrate. The heat treatment process mechanism 53 connects to the delivering chamber 51 and heats the substrate with the printed organic material.

In the embodiment, the ink-jet printing apparatus 5 further comprises a loading mechanism 54, an unloading mechanism 55, a cooling mechanism 56, a pre-treatment mechanism 57 and valves 58, 59. The features and functions of these elements are the same to those same element described in the first embodiment, so the detailed descriptions are omitted here for concise purpose.

In summary, the ink-jet printing apparatus of the invention has proper arrangements as required. Comparing with the conventional art, the invention can change the number of the ink-jet printing devise (ink-jet printing mechanism) and the positions and number of other devices (mechanisms) according to different situations. Thus, the adjustment of the apparatus has better flexibility. For example, when the throughput of the current apparatus is insufficient, the additional ink-jet print chambers (ink-jet print mechanisms) can be installed on the delivering chamber. This can increase the throughput without ordering another apparatus for larger throughput. In addition, when one ink-jet printing device is malfunction, other ink-jet print devices can keep working. Moreover, the organic material is printed in the assigned ink-jet print chamber (ink-jet print mechanism), so time for changing the material can be saved and the pollution of the different organic materials can be prevented. Furthermore, the manually moving is unnecessary in the ink-jet print processes of the invention, so not only the time cost for the manual operation can be saved, but also the organic electroluminescent panel can be prevented from the air, which results in the dark spots. Therefore, the lifetime and reliability of the panel can be assured. In addition, since ink-jet printing apparatus of the invention an automatic and integrated mass production apparatus, so that the throughput can be increased and the yield can be greatly increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An ink-jet printing apparatus for printing at least one organic material on a substrate, comprising:
a delivering chamber, which has a delivering unit for delivering the substrate;
a loading mechanism, which connects to the delivering chamber, wherein the delivering unit carries the substrate from the loading mechanism;
at least one ink-jet printing mechanism, which connects to the delivering chamber and prints the organic material on the substrate;
a heat treatment process mechanism, which connects to the delivering chamber and heats the substrate with the printed organic material; and
an unloading mechanism, which connects to the delivering chamber, wherein the delivering unit carries the substrate to the unloading mechanism.

2. The ink-jet printing apparatus of claim 1, wherein the delivering unit is a robot arm, a transporting axle or a transporting belt.

3. The ink-jet printing apparatus of claim 1, wherein the organic material is at least one selected from the group consisting of buffer layer, hole-injecting layer, hole-transporting layer, electroluminescent layer, electron-transporting layer and electron-injecting layer.

4. The ink-jet printing apparatus of claim 1, wherein the heat treatment process mechanism comprises a heating unit, and the heating unit is a hot plate or an oven.

5. The ink-jet printing apparatus of claim 1, further comprising:
a cooling mechanism, which connects to the delivering chamber and cools the heated substrate.

6. The ink-jet printing apparatus of claim 5, wherein the cooling mechanism comprises a cooling unit, and the cooling unit is a cool plate.

7. The ink-jet printing apparatus of claim 1, further comprising:
a plurality of valves disposed between the delivering chamber and the loading mechanism, the ink-jet printing mechanism, the heat treatment process mechanism and the unloading mechanism.

8. An ink-jet printing apparatus for printing at least one organic material on a substrate, comprising:
a loading device, which comprises a first delivering chamber and a loading chamber connecting to the first delivering chamber;
at least one ink-jet printing device, which comprises a first ink-jet printing chamber and a second delivering chamber connecting to the first ink-jet printing chamber, wherein the second delivering chamber connects to the first delivering chamber;
an unloading device, which comprises a third delivering chamber and an unloading chamber connecting to the third delivering chamber, wherein the third delivering chamber connects to the second delivering chamber;
a plurality of heat treatment process devices, which are disposed between the first delivering chamber and the second delivering chamber, and between the second delivering chamber and the third delivering chamber; and
a plurality of cooling devices, which are disposed between the first delivering chamber and the second delivering chamber, and between the second delivering chamber and the third delivering chamber.

9. The ink-jet printing apparatus of claim 8, wherein the first delivering chamber, the second delivering chamber and the third delivering chamber comprise a delivering unit for delivering the substrate.

10. The ink-jet printing apparatus of claim 8, wherein the loading device further comprises at least one second ink-jet printing chamber connecting to the first delivering chamber.

11. The ink-jet printing apparatus of claim 8, wherein the unloading device further comprises at least one third ink-jet printing chamber connecting to the third delivering chamber.

12. The ink-jet printing apparatus of claim 8, wherein the heat treatment process device comprises a heating unit, and the heating unit is a hot plate.

13. The ink-jet printing apparatus of claim 8, wherein the unloading device further comprises an annealing unit for annealing the substrate.

14. The ink-jet printing apparatus of claim 8, further comprising:
a plurality of valves disposed on the interfaces of the first delivering chamber, the loading chamber, the first ink-jet printing chamber, the second delivering chamber, the third delivering chamber, the unloading chamber, the heat treatment process devices and the cooling devices, respectively.

15. An ink-jet printing apparatus for printing at least one organic material on a substrate, comprising:
a delivering chamber, which comprises a delivering unit for delivering the substrate;
at least one ink-jet printing mechanism, which connects to the delivering chamber and prints the organic material on the substrate; and
a heat treatment process mechanism, which connects to the delivering chamber and heats the substrate with the printed organic material.

16. The ink-jet printing apparatus of claim 15, further comprising:
a loading mechanism, which connects to the delivering chamber, wherein the delivering unit carries the substrate from the loading mechanism.

17. The ink-jet printing apparatus of claim 15, further comprising:
an unloading mechanism, which connects to the delivering chamber, wherein the delivering unit carries the substrate to the unloading mechanism.

18. The ink-jet printing apparatus of claim 15, wherein the organic material is at least one selected from the group consisting of buffer layer, hole-injecting layer, hole-transporting layer, electroluminescent layer, electron-transporting layer and electron injecting layer.

19. The ink-jet printing apparatus of claim 15, further comprising:
a cooling mechanism, which connects to the delivering chamber and cools the heated substrate.

20. The ink-jet printing apparatus of claim 15, further comprising:
a plurality of valves disposed on the interfaces of the delivering chamber and the loading mechanism, the ink-jet printing mechanism, the heat treatment process mechanism and the unloading mechanism, respectively.
